(19) United States
(12) Patent Application Publication
(10) Pub. No.: US 2026/0301328 A1
(43) Pub. Date: Oct. 1, 2026

(54) QUERY-BASED GENERATION OF TRAVERSABLE THREE-DIMENSIONAL SCENES

(71) Applicant: Adobe Inc., San Jose, CA (US)

(72) Inventors: Yiwei Hu, New Haven, CT (US); Zhaoyang Zhang, New Haven, CT (US); Yannick Hold-Geoffroy, Quebec City (CA); Miloš Hašan, Lafayette, CA (US); Fujun Luan, Sunnyvale, CA (US)

(73) Assignee: Adobe Inc., San Jose, CA (US)

(21) Appl. No.: 19/094,967

(22) Filed: Mar. 30, 2025

(51) Int. Cl. G06T 19/00; G06T 15/08; G06T 15/20

(52) U.S. Cl. CPC G06T 19/003; G06T 15/08; G06T 15/20

(57) ABSTRACT

Techniques for generating traversable three-dimensional scenes from text prompts are described and are implementable to create interactive virtual environments. In an example, a text-based query that specifies visual aspects of a desired three-dimensional scene is received. A spherical representation of the scene is generated by processing the query using one or more machine learning models. A traversable three-dimensional scene depicting the specified visual aspects is then constructed by processing the spherical representation using the one or more machine learning models. The traversable scene is output as part of a three-dimensional environment that allows navigation and viewing from multiple perspectives.

### BACKGROUND

Advancements in text-to-image generation have enabled creation of high-quality two-dimensional images from natural language descriptions. However, techniques to generate coherent 3D scenes from text prompts are limited. Existing methods often struggle with excessive generation time, lack of spatial consistency, limited viewpoint flexibility, and an inability to produce traversable three-dimensional environments. Additionally, conventional techniques that attempt to generate three-dimensional renderings based on text prompts are computationally expensive due to reliance on iterative refinement processes and application of complex optimization algorithms. Accordingly, systems that implement such conventional techniques experience computational inefficiency as well as limited scene diversity, fidelity, and geometric consistency which restricts practical applications of such systems.

### SUMMARY

Techniques for query-based generation of traversable three-dimensional scenes are described that support creation of immersive and navigable three-dimensional virtual environments from textual descriptions. In an example, a processing device receives a text-based query that specifies visual aspects to be included in a three-dimensional scene. The processing device generates a spherical representation of the three-dimensional scene by processing the text-based query using a generation model, such as a text-to-video diffusion model that has been fine-tuned on panoramic video data. The spherical representation, for instance, serves as a detailed intermediate that includes panoramic frames that depict visual aspects of the scene from multiple viewpoints.

The processing device then constructs a traversable three-dimensional scene that depicts the specified visual aspects based on the spherical representation. For instance, the processing device inputs the spherical representation to a reconstruction model, such as a long-LRM model, that is configured to generate three-dimensional representations based on the panoramic frames to construct the traversable three-dimensional scene. The processing device then outputs a three-dimensional environment that includes the traversable three-dimensional scene. In this way, the techniques described herein overcome limitations of conventional techniques by generating immersive and high-fidelity virtual environments based on a textual input in a computationally efficient process.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ the query-based generation of traversable three-dimensional scenes techniques described herein.

FIG. 2 depicts a system in an example implementation showing operation of a generation module of FIG. 1 in greater detail.

FIG. 3 depicts an example of query-based generation of traversable three-dimensional scenes to generate training data.

FIG. 4 illustrates an example of query-based generation of traversable three-dimensional scenes in which a traversable three-dimensional scene is generated based on a text input.

FIG. 5 illustrates an example of query-based generation of traversable three-dimensional scenes in which a traversable three-dimensional scene is generated based on a text input.

FIG. 6 illustrates an example of query-based generation of traversable three-dimensional scenes in which a traversable three-dimensional scene is generated based on a text input.

FIG. 7 is a flow diagram depicting an algorithm as a step-by-step procedure in an example implementation that is performable by a processing device to generate and update a three-dimensional environment.

FIG. 8 is a flow diagram depicting an algorithm as a step-by-step procedure in an example implementation that is performable by a processing device to generate a three-dimensional scene based on features of a spherical representation.

FIG. 9 illustrates an example system including various components of an example device that can be implemented as any type of computing device as described and/or utilized with reference to FIGS. 1-8 to implement embodiments of the techniques described herein.

### DETAILED DESCRIPTION

### Overview

Generative AI technologies enable creation of diverse content and thus have a wide range of applications across various domains, such as design, entertainment, education, and scientific research. For instance, text-to-image generation techniques are often used to create two-dimensional digital images based on natural language descriptions. However, techniques to generate coherent three-dimensional scenes remain limited. Manual authoring three-dimensional scenes is time consuming and computationally inefficient, and thus not practical in a variety of implementations.

Additionally, conventional techniques that attempt to generate three-dimensional scenes from text prompts are computationally expensive, such as due to iterative refinement, implementation of complex optimization algorithms, expansive training procedures, and so forth. Further, such techniques generate incomplete scenes that are confined to restricted viewable areas and do not support free navigation. Thus, conventional approaches often require manual adjustment or augmentation, leading to a variety of computational inefficiencies and limited creative control.

Accordingly, techniques for query-based generation of traversable three-dimensional scenes are described that overcome conventional limitations. The techniques described herein, for instance, support creation of immersive and navigable three-dimensional virtual environments from textual descriptions in a computationally efficient process. By leveraging a two-stage pipeline that includes generation of an intermediate spherical representation followed by three-dimensional scene reconstruction, the described techniques achieve improved visual consistency relative to conventional approaches, comprehensive view coverage, and traversability of generated scenes.

Consider an example in which a user of a processing device wishes to visualize a particular architectural design concept for a virtual reality application. The user desires to generate a fully navigable three-dimensional scene of a grand opera house with ornate balconies and a stage under dim lighting. In a conventional scenario, the user would be limited to generating partial scenes with restricted viewpoints or would be forced to rely on time-consuming iterative processes to expand scene coverage. Additionally, conventional techniques often do not maintain visual consistency across different viewpoints and thus fail to produce a cohesive global structure of an environment.

To overcome these limitations, a processing device receives a text-based query that specifies visual aspects to be included in a three-dimensional scene. Continuing with the above example, the query includes the text “a grand opera house stage and ornate balconies under dim lights.” The processing device then generates a spherical representation of the three-dimensional scene by processing the text-based query using a generation model, such as a text-to-video diffusion model that has been fine-tuned on panoramic video data. This spherical representation serves as a detailed intermediate that includes panoramic frames that depict visual aspects of the scene from multiple viewpoints.

The processing device then constructs a traversable three-dimensional scene that depicts the specified visual aspects based on the spherical representation. For example, the processing device inputs the spherical representation to a reconstruction model, such as a long-LRM (large reconstruction model), that is configured to generate three-dimensional representations based on the panoramic frames included in the spherical representation. In various implementations, this process involves extraction of perspective views from the panoramic frames, estimation of virtual poses (e.g., virtual camera poses) for the perspective views, and leveraging the reconstruction model to build a cohesive and traversable three-dimensional scene by processing the perspective frames and associated virtual poses.

The processing device incorporates the traversable three-dimensional scene into a three-dimensional environment, such as for output in a user interface. Continuing with the example, the resulting three-dimensional environment depicts a traversable opera house scene with consistent architectural details, lighting, and spatial relationships across various viewpoints. Accordingly, the user is able to interact with the environment to navigate within the virtual opera house, such as to explore different areas such as the stage, seating areas, and balconies, as well as viewing the scene from various angles and positions, while maintaining visual consistency and realistic spatial relationships throughout the environment.

In this way, the techniques described herein overcome the limitations of conventional systems by generating immersive and high-fidelity virtual environments based on a textual input. The described approach enables creation of comprehensive three-dimensional scenes that are freely navigable rather than partial or constrained viewpoints, offering significantly improved visual consistency, view coverage, and navigability compared to existing approaches.

The described techniques further conserve computational resources compared to conventional techniques in several ways. By utilizing a two-stage pipeline with an intermediate spherical representation, the system avoids computationally expensive iterative refinement processes often employed by traditional methods. Additionally, use of the reconstruction model supports efficient conversion of the spherical representation into a traversable three-dimensional scene without extensive optimization steps that conventional techniques are reliant on. The streamlined approach described herein thus results in reduced processing time and lower computational overhead compared to conventional techniques that rely on progressive scene expansion or complex optimization algorithms. Further discussion of these and other examples and advantages are included in the following sections and shown using corresponding figures.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Term Examples

As used herein, the term “query” refers to an input that specifies one or more visual aspects to be included in a three-dimensional scene. The query, for instance, includes natural language text that describes desired elements, features, or characteristics to be represented in the three-dimensional scene.

As used herein, the term “visual aspect” refers to an element, feature, or characteristic to be represented in a three-dimensional scene. In various embodiments, visual aspects include one or more objects, materials, lighting conditions, details, environmental elements, and/or additional visual properties to be incorporated into a generated three-dimensional scene.

As used herein, the term “generation model” refers to a machine learning model configured to process a query to generate a spherical representation of a three-dimensional scene. In various implementations, the generation model is a text-to-video diffusion model that has been fine-tuned on panoramic video data to perform a panoramic digital content generation task.

As used herein, the term “spherical representation” refers to an intermediate representation used to generate a three-dimensional scene that includes one or more panoramic frames that depict a scene from multiple viewpoints. In various implementations, the spherical representation includes a sequence of 360-degree panoramic video frames that provides spherical visual coverage of a generated scene. The panoramic frames included in the spherical representation are configurable as equirectangular projections that map a three-dimensional spherical surface onto a two-dimensional rectangular plane.

As used herein, the term “reconstruction model” refers to a machine learning model configured to generate three-dimensional representations based on features extracted from a spherical representation. In various implementations, the reconstruction model is a Long-LRM (long-large reconstruction model) that has been trained to generate 3D Gaussian splat representations based on one or more input views.

As used herein, the term “three-dimensional scene” refers to a three-dimensional visual representation of an environment that is traversable to support navigation to view the environment from various viewpoints. The three-dimensional scene is generated by the reconstruction model to incorporate visual aspects specified in a query while maintaining spatial consistency across different viewpoints. In one or more implementations, the traversable three-dimensional scene is represented as a 3D Gaussian splat.

As used herein, the term “three-dimensional environment” refers to a digital representation that includes a traversable three-dimensional scene and supports user interaction and navigation. The three-dimensional environment, for instance, is configurable for output in a user interface of a computing device and includes visual elements and/or selectable indicia to support user interaction and navigation within the environment. In various implementations, the three-dimensional environment enables users to change viewpoints, move through virtual space, and examine different areas of the traversable three-dimensional scene while preserving spatial relationships and visual consistency. The three-dimensional environment supports rendering of views based on navigation inputs, including views that were not explicitly captured in the original spherical representation.

### Example Environment

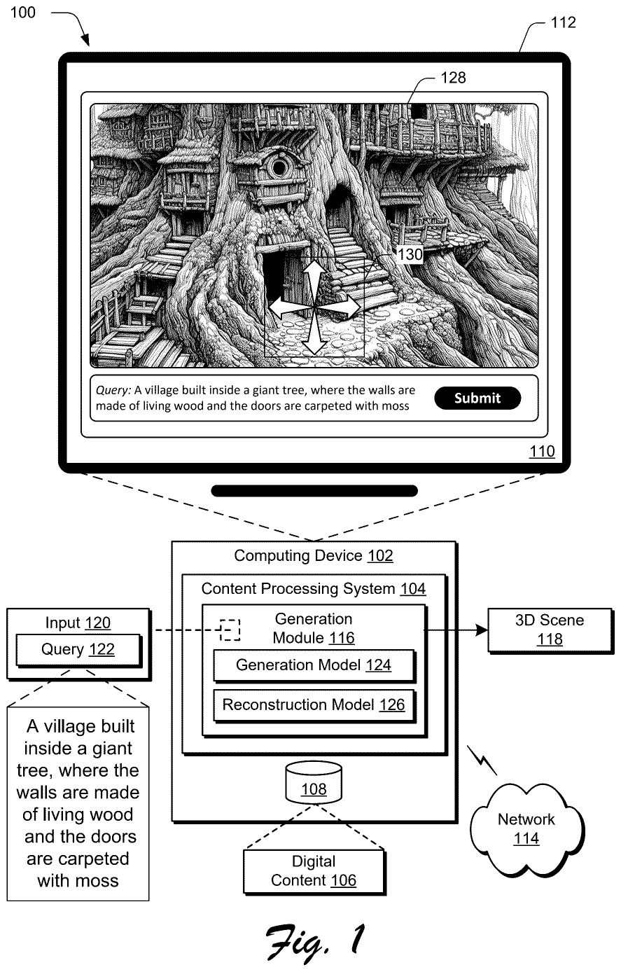

FIG. 1 is an illustration of a digital medium environment 100 in an example implementation that is operable to employ the query-based generation of traversable three-dimensional scenes techniques described herein. The illustrated environment 100 includes a computing device 102, which is configurable in a variety of ways.

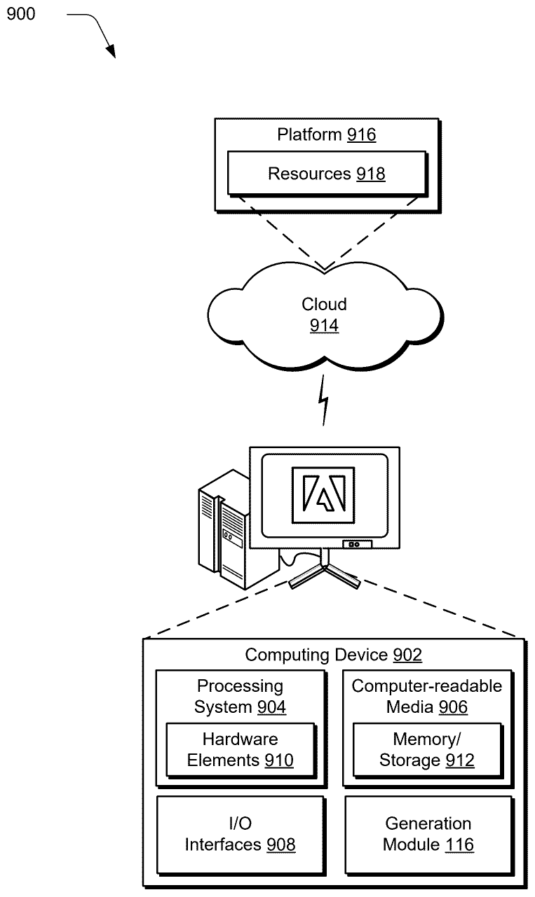

The computing device 102, for instance, is configurable as a processing device such as a desktop computer, a laptop computer, a mobile device (e.g., assuming a handheld configuration such as a tablet or mobile phone as illustrated), and so forth. Thus, the computing device 102 ranges from full resource devices with substantial memory and processor resources (e.g., personal computers, game consoles) to a low-resource device with limited memory and/or processing resources (e.g., mobile devices). Additionally, although a single computing device 102 is shown, the computing device 102 is also representative of a plurality of different devices, such as multiple servers utilized by a business to perform operations “over the cloud” as described in FIG. 9.

The computing device 102 is illustrated as including a content processing system 104. The content processing system 104 is implemented at least partially in hardware of the computing device 102 to process and transform digital content 106, which is illustrated as maintained in storage 108 of the computing device 102. Such processing includes creation of the digital content 106, modification of the digital content 106, and rendering of the digital content 106 in a user interface 110 for output, e.g., by a display device 112. Although illustrated as implemented locally at the computing device 102, functionality of the content processing system 104 is also configurable in whole or in part via functionality available via the network 114, such as part of a web service or “in the cloud.”

An example of functionality incorporated by the content processing system 104 to process the digital content 106 is illustrated as a generation module 116. The generation module 116 is configured to generate traversable three-dimensional scenes, e.g., a 3D scene 118, based on text-based queries. For instance, the generation module 116 receives an input 120 that includes a query 122 specifying one or more visual aspects to be included in the 3D scene 118.

In some examples, the query 122 includes natural language text that describes desired elements, features, or characteristics to be represented in the 3D scene 118. The query 122, for instance, specifies one or more attributes such as objects, materials, lighting conditions, architectural details, environmental elements, and/or other visual properties to be incorporated into the generated 3D scene 118. In various implementations, the query 122 also includes additional parameters and/or constraints, such as a desired style, time period, or mood for the scene.

The query 122 further includes one or more semantic parameters that guides the generation process to create a 3D scene 118 that aligns with the specified visual aspects and/or characteristics. Semantic parameters, for instance, include characteristics, attributes, or elements of the query 122 to be represented in the 3D scene 118. These properties include aspects such as object categories, spatial relationships, material properties, lighting conditions, and contextual information. In an example, semantic properties include identifying an object as a “chair,” specifying its location as “next to a table,” describing its material as “wooden,” or noting the overall lighting as “dim.” These properties provide a structured way to represent and understand the content and context of a query 122, such as beyond visual appearance.

The generation module 116 includes one or more machine learning models that are configurable, such as in a machine learning system, to generate the 3D scene 118 based on the query 122. In the illustrated example, the generation module 116 includes a generation model 124 and a reconstruction model 126. This is by way of example and not limitation, and the generation module 116 is operable to leverage a variety of machine learning models and or algorithms such as but not limited to convolutional neural networks, recurrent neural networks, transformer models, generative adversarial networks, variational autoencoders, diffusion models, reinforcement learning approaches, and so forth.

The generation model 124, for instance, is configured to processes the query 122 to generate an intermediate representation, e.g., a spherical representation, that captures visual details of the scene from multiple viewpoints. As further described in more detail below, in some examples the generation model 124 is a text-to-video model that is fine-tuned through a training process to perform a panoramic video generation task. Accordingly, in some examples the generation model 124 outputs an intermediate spherical representation that include a sequence of panoramic frames, e.g., a 360-degree panoramic video, that depicts the scene from various angles and/or positions. In some examples, the generation module 116 configures the panoramic frames in an equirectangular format that are organized temporally.

The intermediate representation serves as an input to the reconstruction model 126 to construct the traversable 3D scene 118. The reconstruction model 126, for instance, is configured to generate three-dimensional representations based on features extracted from the intermediate representation. As further described in more detail below, in various examples the reconstruction model 126 is a Long-LRM (large reconstruction model) configured to generate Gaussian splats based on various inputs. For example, the reconstruction model 126 extracts one or more perspective views from panoramic frames included in the intermediate representation, estimates virtual poses for the perspective views, and leverages these as inputs to build a cohesive and traversable 3D scene 118.

The generation module 116 is further operable to incorporate the 3D scene 118 into a 3D environment 128 that supports navigation and viewing from one or more viewpoints. In the example depicted in FIG. 1, a user interacts with the user interface 110 displayed on the display device 112 to provide the input 120 containing the query 122. The query 122 includes a textual description such as “a village built inside a giant tree, where the walls are made of living wood and the doors are carpeted with moss.” The generation module 116 processes the query 122 using the generation model 124 to construct the 3D scene 118 which is output as part of the 3D environment 128 in the user interface 110.

The resulting 3D environment 128 supports navigation within the 3D scene 118, such as to allow the user to digitally “explore” the generated village scene. For instance, a navigation control 130 is depicted in the user interface 110 to enable user interaction with the 3D environment 128. The navigation control 130 allows the user to change viewpoints, move through the virtual space, and explore different areas of the generated scene. The generation module 116 is operable to update the view of the 3D environment 128 in real-time as the user interacts with the navigation control 130 while maintaining visual consistency and realistic spatial relationships within the 3D scene 118, which supports responsive exploration of the generated 3D scene 118 with seamless transitions between different viewpoints and positions.

In some examples, this includes generation of viewpoints that were not explicitly represented in the intermediate representation. For instance, the generation module 116 may leverage a structure of the 3D scene 118 to interpolate and/or extrapolate unseen features to support rendering of scene areas that were not directly captured in the initial panoramic video frames. This overcomes the limitations of conventional techniques that generate incomplete scenes and are confined to restricted viewable areas.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Query-Based Generation of Traversable Three-Dimensional Scenes

The following discussion describes techniques that are implementable utilizing the previously described systems and devices. Aspects of each of the procedures are implemented in hardware, firmware, software, or a combination thereof. The procedures are shown as a set of blocks that specify operations performed by one or more devices and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. In portions of the following discussion, reference will be made to FIGS. 1-8.

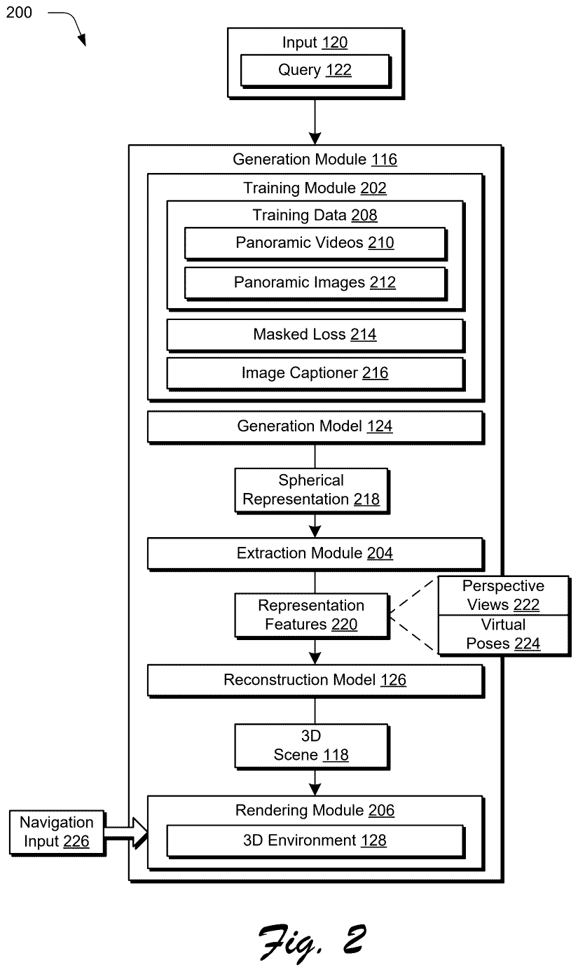

FIG. 2 depicts a system 200 in an example implementation showing operation of a generation module 116 of FIG. 1 in greater detail. Generally, the generation module 116 is configured to generate a 3D environment 128 that includes a 3D scene 118 based on a query 122. In this example, the generation module 116 includes a training module 202, a generation model 124, an extraction module 204, a reconstruction model 126, and a rendering module 206 that interact with one another to process the query 122 and generate a traversable 3D environment 128.

The generation module 116 leverages the training module 202 to train one or more machine learning models, e.g., the generation model 124 and/or the reconstruction model 126, using training data 208 to perform various functionality. In some implementations, the training data 208 includes panoramic videos 210 and/or panoramic images 212. The panoramic videos 210 and panoramic images 212, for instance, depict a wide field of view of a scene such as a 360-degree perspective of a scene. In various examples, the panoramic images 212 and/or frames of the panoramic videos 210 are configurable as equirectangular projections. The training module 202 is further operable to apply a masked loss 214 during training and/or utilize an image captioner 216 to generate the training data 208 as described in the following discussion.

In an example, the training module 202 leverages the training data 208 to train the generation model 124 to generate one or more intermediates in the scene generation process, such as a spherical representation 218, based on the query 122. In various examples, the spherical representation 218 includes panoramic digital content, such as a 360-degree panoramic video that provides spherical visual coverage of a generated scene. Thus, in some examples the spherical representation 218 includes one or more temporally organized panoramic frames, e.g., individual frames of a panoramic video, that are configurable in an equirectangular projection format. In this way, the spherical representation 218 is generated by the generation model 124 to bridge the gap between the text input of the query 122 and the 3D scene 118 and provide context and comprehensive visual details for the reconstruction model 126 to generate the 3D scene 118.

Accordingly, in some examples the generation model 124 is a diffusion model that is fine-tuned for a panoramic digital content generation task, e.g., a text-to-360 video generator. As such, the training module 202 is operable to fine-tune the generation model 124 to generate one or more panoramic frames (e.g., digital images and/or digital videos) based on input text. In various embodiments, the generation model 124 includes a Diffusion Transformer (DiT) architecture that has been fine-tuned on panoramic content data (e.g., the training data 208) to perform panoramic content generation tasks. The DiT model, for instance, incorporates self-attention mechanisms and diffusion-based generation techniques to produce high-quality, temporally consistent panoramic video outputs.

In an example, the generation model 124 is trained on a combination of panoramic videos 210 and panoramic images 212, such as to configure the generation model 124 to be able to generate diverse scenes in videos and images. The panoramic videos 210 and panoramic images 212 are labeled, such as with captions that describe various aspects of scenes depicted by the panoramic video 210 and the panoramic images 212. For example, the training module 202 receives a dataset that includes various unprocessed panoramic images (e.g., approximately 200,000 panoramic images) and leverages an image captioner 216 to generate labels for each of the panoramic images 212. In at least one example, the image captioner 216 is a pretrained Blip-2 image captioner such as described by Li, et al. Blip-2: Bootstrapping Language Image Pre-training with Frozen Image Encoders and Large Language Models. In International Conference on Machine Learning. PMLR, 19730-19742. (2023)

The training module 202 is further operable to configure the panoramic videos 210 as part of the training data 208. For instance, the training module 202 receives a dataset that includes various unprocessed panoramic videos. The training module 202 is operable to segment the unprocessed videos into clips of a predetermined size, e.g., clips that include 128 frames. The training module 202 further leverages an image captioner 216 to generate labels for each of the panoramic videos 210, such as a LLaVA video captioner as described by Liu et al. LLaVA-NeXT. Improved reasoning, OCR, and World Knowledge. (2024).

However, in some implementations, one or more of the panoramic videos 210 and/or panoramic images 212 include undesirable elements, such as depictions of a camera operator, equipment within the frame, and/or other visual artifacts, which negatively impact performance of the generation model 124 once trained. To address this issue, the training module 202 is configured to apply a masked loss 214 (e.g., a masked diffusion loss) during the training process. Via implementation of the masked loss 214, the training module 202 is operable to exclude regions of individual panoramic videos 210 or panoramic images 212 from the training data 208, such as to remove areas that depict extraneous digital content such as a photographer or camera equipment. By selectively applying the masked loss 214, the training module 202 is able to direct learning of the generation model 124 to produce outputs that are free from unwanted elements or artifacts.

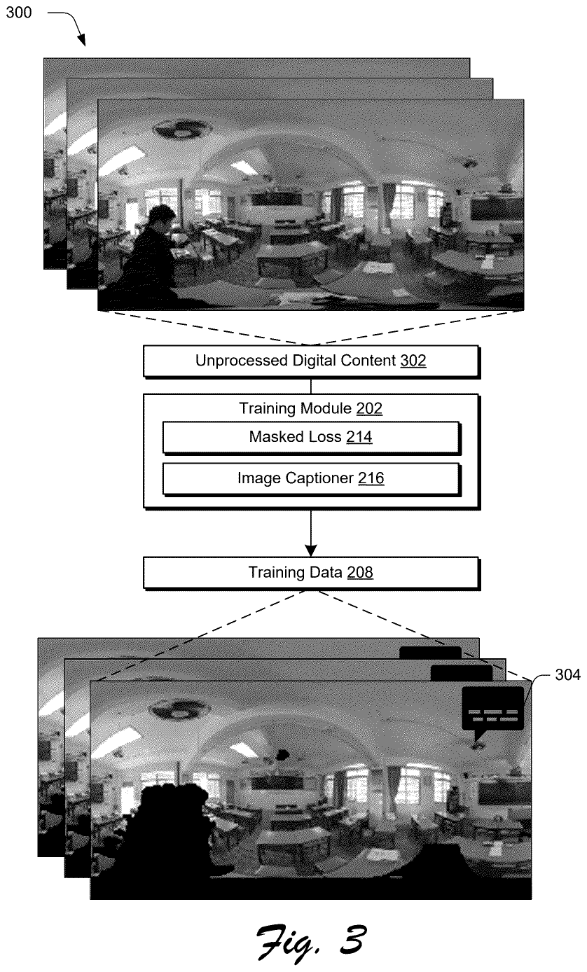

For instance, FIG. 3 depicts an example 300 of query-based generation of traversable three-dimensional scenes to generate training data.

In this example, the training module 202 receives and refines unprocessed digital content 302 (e.g., one or more panoramic digital videos or images) to generate training data 208, such as to use to train the generation model 124. The unprocessed digital content 302 includes a panoramic video depicted as having multiple frames that include undesirable elements, such as representation of an individual depicted on the left portion of a frame of the video and the individual's hand depicted on a bottom portion of the frame.

The training module 202 masks out regions that correspond to the undesirable elements within the frames, such as by leveraging one or more image segmentation models. The training module 202 further masks out a bottom region of the frames based on a probability that the bottom region includes undesirable elements. In at least one example, an area of the masked-out region is based on a determined prevalence of visual artifacts (e.g., unwanted elements) across a dataset of unprocessed digital content 302. The training module 202 continues this process to generate a segmentation mask for each frame in the video and is further operable to merge the segmentation masks into a concatenated binary mask, such as to reduce incidence of segmentation errors.

In an example, the binary mask is denoted M. The training module 202 is operable to resize the binary mask into a latent space of the generation model 124 (e.g., via nearest neighbor interpolation) and compute the masked loss 214 during training as:

$${𝔼}_{x ∼ {p}_{data} , t ∼ U ( 0 , 1 )} [ {‖ M ⊙ ( {ϵ}_{t} - {f}_{θ} ( {\hat{x}}_{t} ; c , t ) ) ‖}^{2} ] ,$$

where ϵₜ is a sampled noise at a timestep t, M has dimensions of ϵₜ, M [i, j]=1 includes a region to be included in the loss calculation, and M [i, j]=0 excludes a region, such as to indicate regions that include an undesirable visual element. Accordingly, implementation of the masked loss 214 enables the training module 202 to train the generation model 124 to produce clean outputs without visual artifacts.

The training module 202 further utilizes an image captioner 216 to generate a caption 304 for each processed item of digital content. The image captioner 216 analyzes visual features of the panoramic videos 210 and panoramic images 212 to create descriptive text captions. Using the captioned training data 208 and the masked loss 214, the training module 202 is operable to train the generation model 124 to generate outputs that align with the using a variety of training schemas.

For instance, the training process includes fine-tuning the generation model 124 on the captioned panoramic video and image data, e.g., using the training module 202 as supervision. In an example, the training module 202 adjusts model parameters and/or learns weights to optimize performance on the panoramic data domain in an iterative process. The training module 202, for instance, employs one or more transfer learning techniques to adapt a partially or wholly pre-trained model for a particular task, e.g., spherical representation 218 generation. The training module 202 is further operable to optimize the generation model 124 using techniques such as stochastic gradient descent to minimize a loss function and further implement the masked loss 214 to exclude particular regions of the training data 208 from contributing to parameter updates. This is by way of example and not limitation and a variety of training procedures and operations are considered.

Returning to FIG. 2, once the one or more machine learning models are trained the generation module 116 receives an input 120 that includes a query 122 that specifies one or more visual aspects to be included in a 3D scene 118. In various implementations, the query 122 includes natural language text that describes desired elements, features, or characteristics to be represented in the 3D scene 118. As described above, the query 122 is defined by one or more semantic properties such as object categories, spatial relationships, material properties, lighting conditions, and contextual information. Accordingly, the visual aspects include but are not limited to objects, materials, lighting conditions, architectural details, environmental elements, desired style, mood, time period, and/or other visual properties to be incorporated into the generated 3D scene 118.

The generation module 116 leverages the trained generation model 124 to process the query 122 to generate a spherical representation 218 of the three-dimensional scene. In some implementations, the spherical representation 218 includes a sequence of panoramic frames that depict visual aspects of the scene from multiple viewpoints. In one or more examples, the generation module 116 configures the sequence of panoramic frames as temporally organized 360-degree equirectangular projections. For instance, the generation module 116 is operable to map a three-dimensional spherical surface onto a two-dimensional rectangular plane. Thus, the spherical representation 218 provides comprehensive visual details from various angles and positions, such as to enable reconstruction of the 3D scene 118 by the reconstruction model 126 as described below.

The spherical representation 218 functions as a comprehensive intermediate format that captures visual information of the desired scene from multiple perspectives. By providing a 360-degree view of the environment, the spherical representation 218 encapsulates detailed visual information across the scene such as spatial relationships, lighting conditions, textures, and object placements throughout the scene. Further, the spherical representation 218 is relatively computationally inexpensive to generate compared to techniques that attempt to generate three-dimensional content “all at once.”

Thus, the various angles and/or positions captured in the spherical representation 218 support efficient and accurate 3D reconstruction. For instance, the spherical representation 218 enables the reconstruction model 126 to resolve ambiguities that would otherwise arise from occlusions or complex geometries when viewed from a single angle, e.g., from a two-dimensional image. For instance, portions of objects that are hidden from a first viewpoint are visible from a second viewpoint in the spherical representation 218, which provides additional context for reconstruction.

Accordingly, the reconstruction model 126 is operable to receive one or more features of the spherical representation 218 and process the features to reconstruct the 3D scene 118. In one example, the reconstruction model 126 processes the spherical representation 218 directly to generate the 3D scene 118. In an alternative or additional example, the extraction module 204 processes the spherical representation 218 to obtain one or more representation features 220. In various implementations, the representation features 220 include perspective views 222 and/or virtual poses 224 extracted from the panoramic frames included in the spherical representation 218.

By way of example, the extraction module 204 receives a spherical representation 218 with a plurality of panoramic frames (e.g., 128 frames with a 360-degree field of view) configured as equirectangular projections. The extraction module 204 then performs a perspective crop operation to generate one or more perspective views for each frame. In some embodiments, the perspective crop operation involves extracting portions of the equirectangular panoramic frames to create images with a reduced field of view, e.g., a 120-degree field of view. Accordingly, the generated perspective views depict an appearance of the scene from particular viewpoints within the environment, such as how a traditional camera would depict the scene from a particular viewpoint.

The extraction module 204 is operable to perform multiple perspective crops on each panoramic frame to obtain a diverse set of perspective views 222. In some implementations, the extraction module 204 may extract a predetermined number (e.g., three to five) perspective views 222 from different locations within each frame. The extraction module 204 is further able to select locations for the crops based on various factors, such as randomly, at evenly distributed angles around the 360-degree panorama, areas of high visual interest, and/or regions that capture relevant elements of the scene.

For example, the extraction module 204 performs the perspective crop operation at 0, 120, and 240 degrees horizontally, while also varying a vertical angle to capture both eye-level and elevated perspectives. In additional or alternative example, a number and position of the crops is dynamically adjusted based on content of the scene, such as to capture a relatively high number of perspective views 222 from areas of the scene that include complex geometry and/or significant visual elements. Conversely, the extraction module 204 is operable to obtain relatively few perspective views 222 from frame regions identified as uniform and/or with lower visual significance, e.g., flat areas or regions without objects. This adaptive approach allows the system 200 to efficiently allocate processing resources while supporting high-quality reconstruction results.

In at least one example, a number and position of perspective views 222 per frame is based in part on computational efficiency considerations. In various implementations, a number and position of perspective views 222 extracted from each panoramic frame impacts computational resources used for reconstruction. For instance, relatively few perspective views reduces an overall data volume and computational load, which increases processing speed of the reconstruction process at the potential expense of accuracy and fidelity.

Accordingly, the extraction module 204 is configurable to consider factors such as available processing power, memory constraints, and/or desired reconstruction speed when extracting the perspective views 222. In an example scenario where rapid scene generation is prioritized, the extraction module 204 extracts a relatively low number of strategically extracted perspective views 222, such as to reduce processing time. In an additional or alternative scenario where reconstruction accuracy and scene fidelity is prioritized, the extraction module 204 generates a relatively high number of perspective views 222 per frame, such as to capture comprehensive scene information.

In this way, the extraction module 204 is able to gather a comprehensive set of perspective views 222 that provide varied information for input to the reconstruction model 126 and thereby improve accuracy and detail in the 3D scene 118 while maintaining computational efficiency and improving operations of devices that implement the techniques described herein.

The extraction module 204 further generates virtual poses 224 for each of the perspective views 222. The virtual poses 224, for instance, include virtual camera poses that represent an estimated position and/or orientation of a virtual camera for each extracted perspective view 222. In at least one example, the extraction module 204 leverages a structure from motion algorithm to generate the virtual poses 224, such as a COLMAP pipeline as described by Schönberger, et al. Structure-from-Motion Revisited. In Conference on Computer Vision and Pattern Recognition. (2016). The virtual poses 224 provide the reconstruction model 126 with context to understand spatial relationships between various parts of the scene and accurately insert three dimensional elements into the reconstructed environment.

The reconstruction model 126 receives the representation features 220 as input and generates the 3D scene 118. For instance, the reconstruction model 126 processes the perspective views 222 and/or the virtual poses 224 using various machine learning techniques to generate the 3D scene 118. In various implementations, the reconstruction model 126 is a Long-LRM (Large Reconstruction Model) that has been trained (such as by the training module 202 and/or received as a pretrained model) to generate 3D Gaussian splat representations based on one or more input views. The reconstruction model 126 is thus configured to leverage the diverse set of perspective views 222 and corresponding virtual poses 224 to build a coherent and detailed 3D scene 118.

In an example, the reconstruction model 126 analyzes the perspective views 222 to identify salient features and geometric relationships within the scene. The reconstruction model 126 then uses the virtual poses 224 to identify one or more spatial relationships between the salient features across different viewpoints, such as to infer a three-dimensional structure of the scene, including depth, object placement, and overall layout. Leveraging this insight, the reconstruction model 126 generates a dense point cloud representation of the scene. Each point in the cloud representation is associated with color information, such as derived from the input views. The reconstruction model 126 then converts this point cloud into a 3D Gaussian splat representation, such that each point is replaced by a 3D Gaussian function that describes local surface properties. The 3D Gaussian splat supports efficient real-time rendering of complex scenes that are able to be dynamically adjusted.

Accordingly, the output of the reconstruction model 126 is a 3D scene 118 that captures a geometry, texture, and lighting information of the environment described in the query 122. The 3D scene 118 further includes the visual aspects specified in the query 122, such as objects, materials, lighting conditions, architectural details, environmental elements, and/or other visual properties. The 3D scene 118 is further traversable and navigable, such that the scene supports virtual movement and exploration within the virtual environment depicted by the 3D scene 118 from various perspectives while maintaining visual consistency.

The rendering module 206 is operable to generate a 3D environment 128 for output that includes the 3D scene 118. For instance, the 3D environment 128 is a digital representation of the 3D scene 118 that is rendered and able to be interacted with through a computing device 102. In an example, the rendering module 206 configures the 3D environment 128 for output, such as in a user interface 110 of a computing device 102. In some examples, the rendering module 206 configures the 3D environment 128 with visual elements and/or selectable indicia to support user interaction and navigation within the 3D environment 128.

In one or more implementations, the rendering module 206 receives a navigation input 226, such as an input to navigate within the 3D environment 128 and/or the 3D scene 118. The navigation input 226, for instance, defines an update to a viewpoint or position within the 3D environment 128 and/or the 3D scene 118. The rendering module 206 is operable to process the navigation input 226 to adjust the displayed view, such as by rotating a camera angle, moving to a different location within the scene, zooming in/out, and so forth. In one or more examples, the navigation input 226 includes one or more user interface 110 interactions, mouse clicks, keyboard commands, AR/VR controller inputs, touch gestures, and so forth.

Based on the navigation input 226, the rendering module 206 is able to generate views of the 3D scene 118 to update a portion of the 3D environment 128 that is depicted. In an example, the rendering module 206 processes the navigation input 226 to determine an updated viewpoint or position within the 3D scene 118. The rendering module 206 is further operable to leverage spatial information captured in the 3D scene 118, e.g., in the 3D Gaussian splat representation, to efficiently render the updated view.

For instance, the rendering module 206 first determines which portion or portions of the 3D Gaussian splat is visible from the updated viewpoint. The reconstruction model 126 then projects visible portions from the updated viewpoint onto a two-dimensional plane, taking into account factors such as occlusion, perspective, and lighting. The rendering module 206 then blends the projected portions to create a smooth, coherent image that accurately represents the scene from the new viewpoint. In this way, the rendering module 206 enables dynamic generation of various views of the scene, including views that were not explicitly captured in the spherical representation 218.

Accordingly, the techniques described herein support generation of a traversable, navigable 3D scene 118 that allows a user to change viewpoints, move through a virtual space, and examine different areas of the 3D environment 128 while preserving spatial relationships and visual consistency within the 3D environment 128. This overcomes limitations of conventional techniques that rely on static 3D models or limited-view representations, as the techniques described herein provide a dynamic, interactive experience to explore an expansive region of the generated environment that includes areas that were not captured in the spherical representation 218. Thus, the traversable and navigable nature of the 3D scene 118 supports a wide range of applications, such as augmented reality and/or virtual reality (AR/VR) experiences to visualize various content.

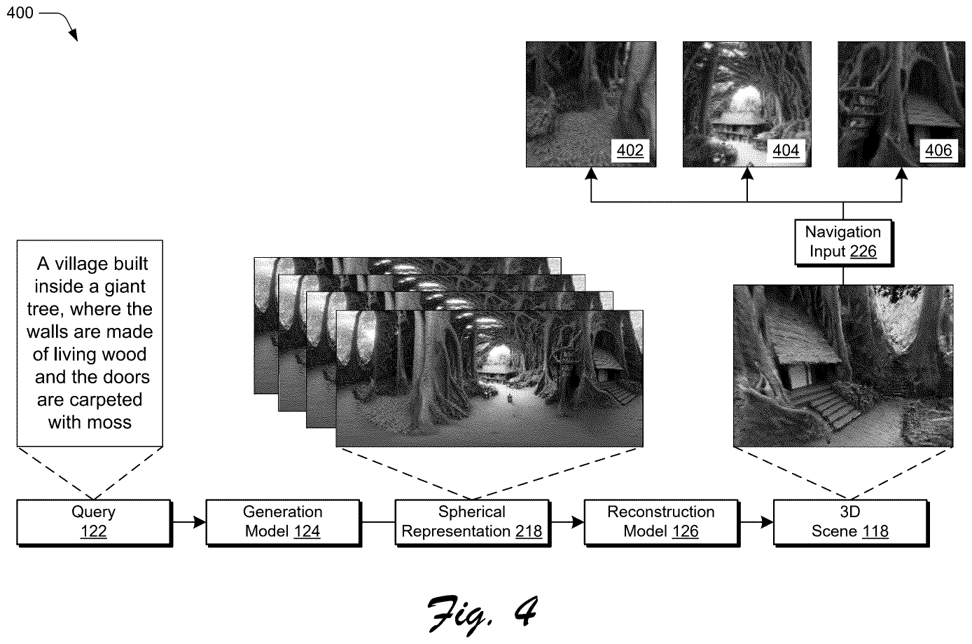

FIG. 4 illustrates an example 400 of query-based generation of traversable three-dimensional scenes in which a traversable three-dimensional scene is generated based on a text input.

In this example, a query 122 is received by the generation module 116 that specifies visual aspects to be included in a three-dimensional scene, such as objects, materials, and additional details. For instance, the query 122 includes the text “a village built inside a giant tree, where the walls are made of living wood and the doors are carpeted with moss.” Thus, the visual aspects include features explicitly included in the query 122 such as a village structure, a giant tree that houses the village, and walls made of living wood, doors covered with moss. The generation module 116 is further able to infer properties to include based on semantic properties of the query 122, such as an overall integration of the village within a structure of the tree, a tone/mood of the scene, organic and natural elements of the environment, and particular architectural features that blend the village with the tree.

In accordance with the techniques described above, the generation model 124 processes the query 122 to create a spherical representation 218 of the three-dimensional scene. In this example, the spherical representation 218 includes a sequence of panoramic frames of a 360-degree panoramic video that are configured as equirectangular projections. As illustrated, the spherical representation 218 depicts the visual elements specified by the query 122, such as a village constructed within a large tree, walls that include textures and patterns that resemble living wood, and doors that include moss-like textures.

The frames of the spherical representation 218 further capture various aspects of the scene from multiple viewpoints across a temporal dimension, such as to show subtle changes in perspective or lighting and simulate movement through the environment and/or the passage of time. For instance, the spherical representation 218 simulates a “walkthrough” of the described environment to provide comprehensive visual details from multiple viewpoints.

Accordingly, the spherical representation 218 serves as an intermediate representation in the scene generation process that captures visual and spatial information that is leveraged by the reconstruction model 126 to generate the final 3D scene 118. The spherical representation 218 includes details that are not explicitly mentioned in the query and instead are inferred based on the semantic properties of the query 122, such as the integration of natural and constructed elements, an organic flow of spaces within the tree, and an overall atmosphere of a fantastical tree-village.

The spherical representation 218 is then provided as input to the reconstruction model 126. The reconstruction model 126 processes the spherical representation 218 to generate the 3D scene 118. The 3D scene 118 is traversable and incorporates the visual aspects specified in the query 122. In this example, the 3D scene 118 includes a detailed representation of a village integrated within a giant tree. The scene features walls with textures and patterns resembling living wood, doors adorned with moss-like coverings, and an organic flow of spaces that blend seamlessly with a structure of the tree. Additionally, the 3D scene 118 includes various lighting effects and environmental details to enhance realism of the depicted tree-village.

The 3D scene 118 is further traversable and navigable such as to support rendering from multiple perspectives or positions. For instance, a first view 402, a second view 404, and a third view 406 are depicted that illustrate different viewpoints within the generated 3D environment. In some implementations, the rendering module 206 is operable to generate the different views based on one or more navigation inputs 226. These views demonstrate how the 3D scene 118 enables navigation and visualization of the environment from various angles and positions while maintaining visual consistency. Thus, a user interacting with a 3D environment 128 that includes this 3D scene 118 is able to explore various levels, pathways, and living spaces within the tree-village.

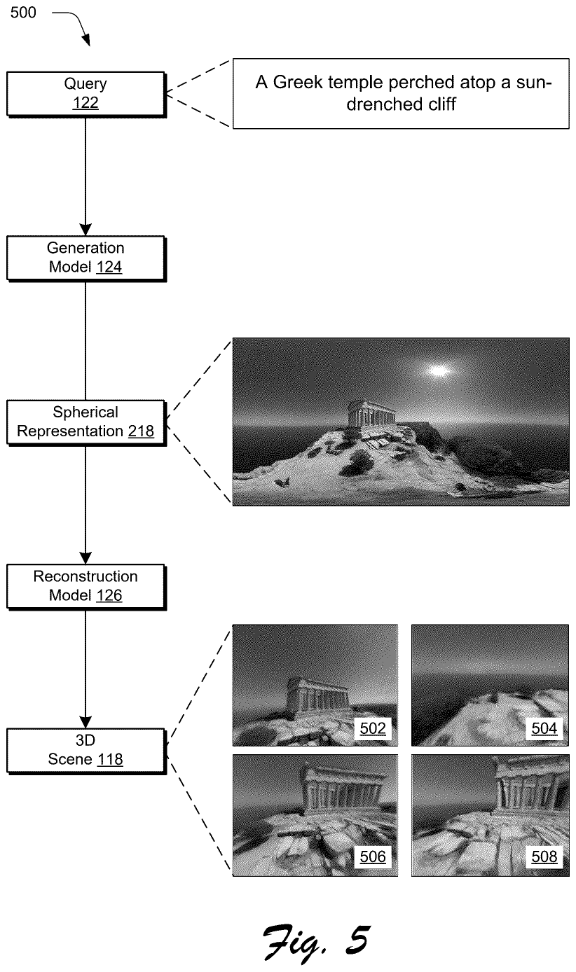

FIG. 5 illustrates an example 500 of query-based generation of traversable three-dimensional scenes in which a traversable three-dimensional scene is generated based on a text input.

In this example, a query 122 is receive that includes the text “a Greek temple perched atop a sun-drenched cliff.” The generation model 124 processes the query 122 to create a spherical representation 218 of the three-dimensional scene. The spherical representation 218, for instance, includes a 360-degree panoramic video that capture various aspects of the scene from multiple viewpoints across a temporal dimension. For instance, the spherical representation 218 depicts a walkthrough of a scene that includes a Greek temple situated on top of a sun-drenched cliff, as specified by the query 122.

As illustrated, the spherical representation 218 integrates features explicitly described by the query 122 with features inferred by the generation module 116. For instance, the spherical representation 218 includes panoramic frames that capture architectural features of the temple (e.g., columns, pediments, steps, etc.) as well as the surrounding rocky terrain of the cliff. The spherical representation 218 represents the “sun-drenched” aspect through warm lighting effects, long shadows, and a bright hue. The spherical representation 218 further includes different perspectives of the scene.

The reconstruction model 126 then processes the spherical representation 218 to generate a traversable 3D scene 118 that incorporates the visual aspects specified in the query 122. In this example, the 3D scene 118 includes a detailed representation of a Greek temple situated on a cliff, with architectural elements such as columns and pediments, as well as the surrounding rocky terrain and lighting effects that convey a sun-drenched atmosphere. In accordance with the techniques described herein, the 3D scene 118 is traversable and navigable and supports rendering from various perspectives and positions.

For instance, a first view 502, a second view 504, a third view 506, and a fourth view 508 depict various viewpoints within the 3D scene 118. For example, the first view 502 depicts a side perspective of the temple, the second view 504 depicts a view that emphasizes a position of the temple on the cliff edge, the third view 506 provides a side view looking up at the temple, and the fourth view 508 depicts a view from behind the temple with a downward perspective.

In some implementations, the rendering module 206 is operable to generate the different views based on one or more navigation inputs 226, such as inputs to navigate within the 3D scene 118. For example, the first view 502 is generated responsive to a navigation input 226 to move a virtual camera to a position near the temple, looking upward. The fourth view 508, on the other hand, is generated responsive to a navigation input 226 to move the virtual camera to a position adjacent to the temple and angling the virtual camera slightly downward.

Accordingly, the views demonstrate how the 3D scene 118 enables navigation and visualization of the environment from various angles and positions while maintaining visual consistency. For instance, the multiple views of the 3D scene 118 maintain consistent architectural details, lighting conditions, and spatial relationships across different perspectives. For example, an appearance of the columns of the temple, the texture of the cliff face, and the bright hues of sunlight remain consistent across the views 502, 504, 506, and 508.

Further, the traversable 3D scene 118 depicts viewpoints not explicitly represented in the original spherical representation 218. For instance, the rendering module 206 is operable to generate novel views by interpolating between captured perspectives or extrapolating scene geometry. This capability allows for seamless navigation and exploration of the environment, including areas that were not directly captured in the panoramic video of the spherical representation 218.

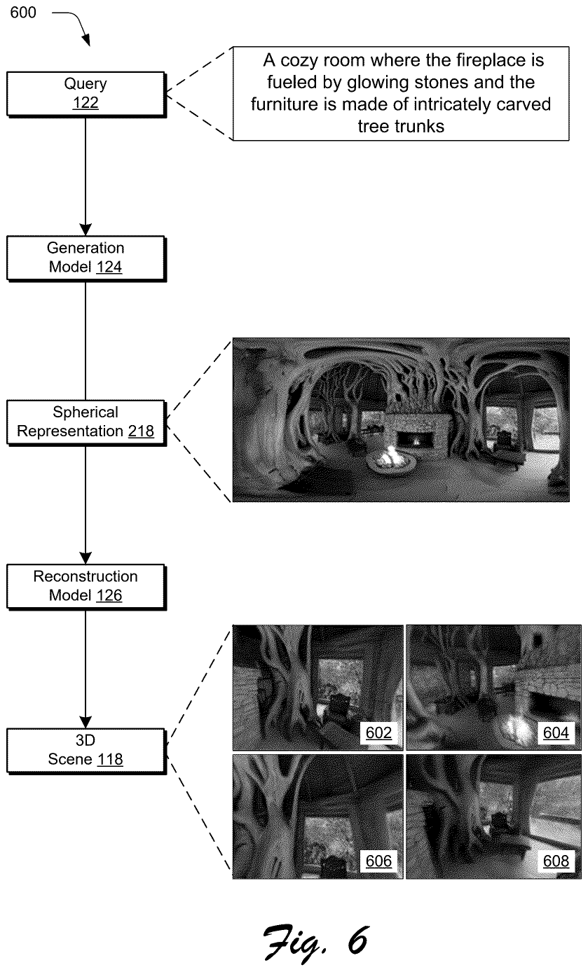

FIG. 6 illustrates an example 600 of query-based generation of traversable three-dimensional scenes in which a traversable three-dimensional scene is generated based on a text input.

In this example, a query 122 is received that includes the text “a cozy room where the fireplace is fueled by glowing stones and the furniture is made of intricately carved tree trunks.” The generation model 124 processes the query 122 to create a spherical representation 218 of the three-dimensional scene. For instance, the spherical representation 218 depicts a walkthrough of a scene that includes a cozy room with a fireplace and furniture, as specified by the query 122.

As illustrated, the spherical representation 218 integrates features explicitly described by the query 122 with features inferred by the generation module 116. For instance, the spherical representation 218 includes a 360-degree view that depicts a fireplace with glowing stones, furniture crafted from tree trunks with intricate carvings, as well as an overall “cozy” atmosphere of the room. The spherical representation 218 represents the “cozy” visual aspect using warm lighting effects, soft textures, and an intimate scale. The spherical representation 218 further includes different perspectives of the scene.

The reconstruction model 126 then processes the spherical representation 218 to generate a traversable 3D scene 118 that incorporates the visual aspects specified in the query 122. In this example, the 3D scene 118 includes a detailed representation of a cozy room, with a fireplace featuring glowing stones, furniture made from intricately carved tree trunks, as well as additional elements that contribute to the cozy atmosphere. In accordance with the techniques described herein, the 3D scene 118 is traversable and navigable and supports rendering from various perspectives and positions.

For instance, a first view 602, a second view 604, a third view 606, and a fourth view 608 depict various viewpoints within the 3D scene 118. For example, the first view 602 depicts a perspective of a tree and a chair to the right of the fireplace, the second view 604 provides a view of the fireplace with glowing stones, the third view 606 includes a view out of a window, and the fourth view 608 offers a wide view of the fireplace and window.

Notably, the traversable 3D scene 118 depicts visual content that is not explicitly represented in the spherical representation 218. For instance, the rendering module 206 is operable to generate unseen visual content, such as by leveraging information included in the 3D scene 118 by the reconstruction model 126. In an example, the reconstruction model 126 implements spatial reasoning and contextual understanding learned during training to infer and generate “unseen” visual content, such as to extend the scene beyond explicitly captured views in the spherical representation 218. In the illustrated example, unseen content includes areas behind furniture or objects that were not directly visible in the original panoramic frames, such as backsides of trees, contours of the fireplace, perspectives of the furniture, and so forth. This overcomes limitations of conventional techniques that are constrained to display of a limited viewable area.

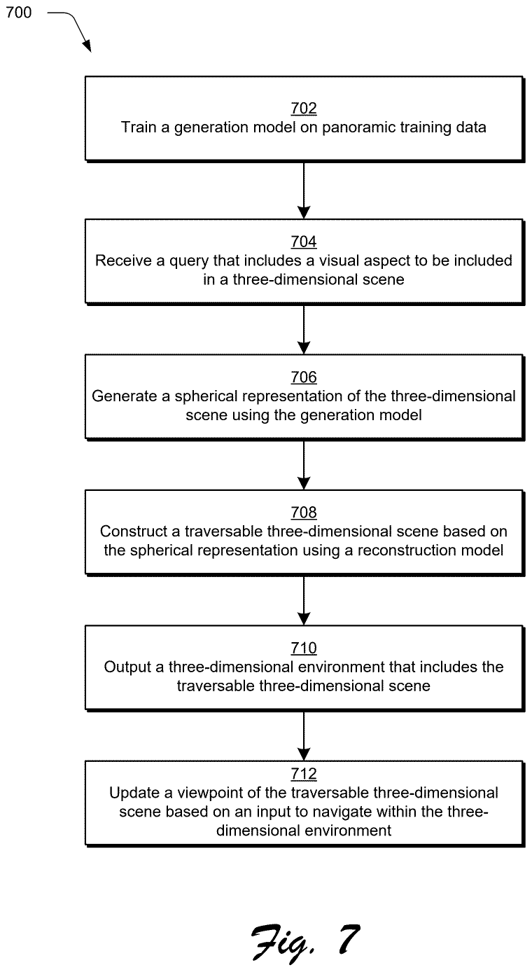

FIG. 7 is a flow diagram depicting an algorithm as a step-by-step procedure 700 in an example implementation that is performable by a processing device to generate and update a three-dimensional environment.

To begin in this example, a generation model is trained on panoramic training data (block 702). The panoramic training data, for instance, includes panoramic videos 210 and/or panoramic images 212. In one or more examples, training the generation model 124 includes adjusting weights and/or parameters of the generation model 124 based on processing of the training data 208. In some implementations, the generation module 116 applies a masked loss 214 during training to account for unwanted visual artifacts included in the training data 208.

Once the generation model is trained, a query that includes a visual aspect to be included in a three-dimensional scene is received (block 704). The query 122, for instance, specifies one or more visual aspects such as objects, materials, lighting conditions, architectural details, environmental elements, and/or other visual properties to be incorporated into the generated 3D scene 118. In an example, the query 122 specifies what the 3D scene 118 is to “look like” and/or what the 3D scene 118 is to include.

A spherical representation of the three-dimensional scene is then generated using the generation model (block 706). In various implementations, the generation model 124 processes the query 122 to create the spherical representation 218, such as based on visual aspects and/or semantic properties of the query 122. The spherical representation 218, for instance, includes a sequence of panoramic frames that depict visual aspects of the scene from multiple viewpoints. In some examples, one or more of the panoramic frames are configured as equirectangular projections.

A traversable three-dimensional scene is constructed based on the spherical representation using a reconstruction model (block 708). For instance, the reconstruction model 126 is a three-dimensional Gaussian Splat (3DGS) reconstructor that transforms two-dimensional visual data into a renderable three-dimensional scene representation using Gaussian splats. The reconstruction model 126 generates the 3D scene 118 to be traversable, such as to support navigation within the environment depicted by the 3D scene 118 and to dynamically render views of the 3D scene 118 in real time from various positions and perspectives.

A three-dimensional environment that includes the traversable three-dimensional scene is output (block 710). For instance, the generation module 116 is operable to generate the 3D environment 128 for output that includes the 3D scene 118. In some implementations, the rendering module 206 configures the 3D environment 128 for output in the user interface 110 of the computing device 102. In various examples, the 3D environment 128 includes navigational elements and/or UI icons to support navigation within the 3D scene 118.

A viewpoint of the traversable three-dimensional scene is updated based on an input to navigate within the three-dimensional environment (block 712). In various implementations, the generation module 116 receives a navigation input 226 to navigate within the 3D environment 128 and/or the 3D scene 118. The generation module 116 is operable to process the navigation input 226 to adjust the displayed view, such as by rotating a camera angle, moving to a new location in the scene, zooming in/out, and so forth.

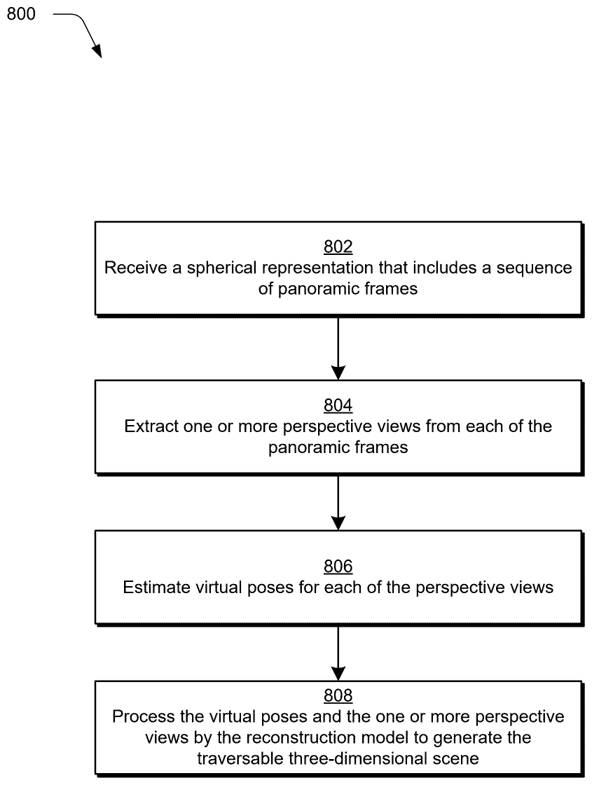

FIG. 8 is a flow diagram depicting an algorithm as a step-by-step procedure 800 in an example implementation that is performable by a processing device to generate a three-dimensional scene based on features of a spherical representation. In some examples, one or more of the steps of the procedure 800 are implementable as substeps of block 708 of FIG. 7. For instance, in this procedure 800 the 3D scene 118 generated in block 708 is based on one or more representation features 220.

To begin in this example, a spherical representation that includes a sequence of panoramic frames is received (block 802). The spherical representation 218, for instance, includes a sequence of 360-degree panoramic video frames that capture various aspects of the scene from multiple viewpoints across a temporal dimension. In various implementations, the panoramic frames are configured as equirectangular projections that map three-dimensional aspects of the spherical representation 218 onto a two-dimensional plane.

One or more perspective views are then extracted from each of the panoramic frames (block 804). In some implementations, the generation module 116 performs a perspective crop operation to generate one or more perspective views 222 for each panoramic frame. The perspective views 222, for instance, depict an appearance of the scene of the spherical representation 218 from various viewpoints within the environment, such as how a traditional camera would capture the scene from a particular position and angle.

Virtual poses are estimated for each of the perspective views (block 806). The virtual poses 224, for instance, represent an estimated position and/or orientation of a virtual camera for each perspective view 222. The virtual poses 224, e.g., virtual camera poses, provide the reconstruction model 126 with context to understand spatial relationships between various parts of the scene. In some implementations, a structure from motion algorithm, e.g., COLMAP, is used to generate the virtual poses 224 for each extracted perspective view 222.

The virtual poses and the one or more perspective views are processed by the reconstruction model to generate the traversable three-dimensional scene (block 808). In one or more implementations, the reconstruction model 126 analyzes the perspective views 222 to identify salient features and geometric relationships within the scene. The reconstruction model 126 then uses the virtual poses 224 to identify spatial relationships between the salient features across different viewpoints, such as to infer a three-dimensional structure of the scene, including depth, object placement, and overall layout. Accordingly, the resulting traversable 3D scene 118 incorporates the visual aspects specified in the query 122 while maintaining spatial consistency across different viewpoints.

The previous examples describe multiple instances of machine-learning models. Machine-learning models refers to a computer representation that is tunable (e.g., through training and retraining) based on inputs without being actively programmed by a user to approximate unknown functions, automatically and without user intervention. In particular, the term machine-learning model includes a model that utilizes algorithms to learn from, and make predictions on, known data by analyzing training data to learn and relearn to generate outputs that reflect patterns and attributes of the training data.

Examples of machine-learning models include neural networks, convolutional neural networks (CNN's), long short-term memory (LSTM) neural networks, generative adversarial networks (GAN's), decision trees, support vector machines, linear regression, logistic regression, Bayesian networks, random forest learning, dimensionality reduction algorithms, boosting algorithms, deep learning neural networks, etc.

A machine-learning model, for instance, is configurable using a plurality of layers having, respectively, a plurality of nodes. The plurality of layers are configurable to include an input layer, an output layer, and one or more hidden layers. Calculations are performed by the nodes within the layers via hidden states through a system of weighted connections that are “learned” during training of the machine-learning model to implement a variety of tasks.

In order to train the machine-learning model, training data is received that provides examples of “what is to be learned” by the machine-learning model, i.e., as a basis to learn patterns from the data. The machine-learning system, for instance, collects and preprocesses the training data that includes input features and corresponding target labels, i.e., of what is exhibited by the input features. The machine-learning system then initializes parameters of the machine-learning model, which are used by the machine-learning model as internal variables to represent and process information during training and represent interferences gained through training. In an implementation, the training data is separated into batches to improve processing and optimization efficiency of the parameters of the machine-learning model during training.

The training data is then received as an input by the machine-learning model and used as a basis for generating predictions based on a current state of parameters of layers and corresponding nodes of the model, a result of which is output as output data, e.g., a search result, prompt, and so forth.

Training of the machine-learning model includes calculating a loss function to quantify a loss associated with operations performed by nodes of the machine learning model. The calculating of the loss function, for instance, includes comparing a difference between predictions specified in the output data with target labels specified by the training data. The loss function is configurable in a variety of ways, examples of which include regret, Quadratic loss function as part of a least squares technique, and so forth.

Configuration of the training data is usable to support a variety of usage scenarios. In one example, the training data is configured for natural language processing, e.g., to infer intent, locate items, generate prompts, and so forth. A variety of other examples are also contemplated, included the large language models (LLMs) as previously described.

### Example System and Device

FIG. 9 illustrates an example system generally at 900 that includes an example computing device 902 that is representative of one or more computing systems and/or devices that implement the various techniques described herein. This is illustrated through inclusion of the generation module 116. The computing device 902 is configurable, for example, as a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that is configurable as processors, functional blocks, and so forth. This includes implementation in hardware as an application specific integrated circuit or other logic device formed using one or more semiconductors. The hardware elements 910 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 906 is illustrated as including memory/storage 912. The memory/storage 912 represents memory/storage capacity associated with one or more computer-readable media. The memory/storage 912 includes volatile media (such as random access memory (RAM)) and/or nonvolatile media (such as read only memory (ROM), Flash memory, optical disks, magnetic disks, and so forth). The memory/storage 912 includes fixed media (e.g., RAM, ROM, a fixed hard drive, and so on) as well as removable media (e.g., Flash memory, a removable hard drive, an optical disc, and so forth). The computer-readable media 906 is configurable in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 902. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable, and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 902, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also employed to implement various techniques described herein. Accordingly, software, hardware, or executable modules are implemented as one or more instructions and/or logic embodied on some form of computer-readable storage media and/or by one or more hardware elements 910. The computing device 902 is configured to implement particular instructions and/or functions corresponding to the software and/or hardware modules. Accordingly, implementation of a module that is executable by the computing device 902 as software is achieved at least partially in hardware, e.g., through use of computer-readable storage media and/or hardware elements 910 of the processing system 904. The instructions and/or functions are executable/operable by one or more articles of manufacture (for example, one or more computing devices 902 and/or processing systems 904) to implement techniques, modules, and examples described herein.

The techniques described herein are supported by various configurations of the computing device 902 and are not limited to the specific examples of the techniques described herein. This functionality is also implementable all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 include applications and/or data that can be utilized while computer processing is executed on servers that are remote from the computing device 902. Resources 918 can also include services provided over the Internet and/or through a subscriber network, such as a cellular or Wi-Fi network.

The platform 916 abstracts resources and functions to connect the computing device 902 with other computing devices. The platform 916 also serves to abstract scaling of resources to provide a corresponding level of scale to encountered demand for the resources 918 that are implemented via the platform 916. Accordingly, in an interconnected device embodiment, implementation of functionality described herein is distributable throughout the system 900. For example, the functionality is implementable in part on the computing device 902 as well as via the platform 916 that abstracts the functionality of the cloud 914.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
receiving, by a processing device, a text-based query that specifies a visual aspect to be included in a three-dimensional scene;
generating, by processing the text-based query using one or more machine learning models, a spherical representation of the three-dimensional scene; and
constructing, for output by the processing device, a three-dimensional environment that includes a traversable three-dimensional scene that depicts the visual aspect, the constructing including processing the spherical representation using the one or more machine learning models.

2. The method as described in claim 1, wherein the traversable three-dimensional scene includes a 3D Gaussian Splat representation.

3. The method as described in claim 1, wherein the generating the spherical representation includes using a text-to-video diffusion model fine-tuned on panoramic video data to process the text-based query.

4. The method as described in claim 1, wherein the spherical representation includes a sequence of frames of a 360-degree panoramic video.

5. The method as described in claim 4, wherein the constructing the three-dimensional environment includes:
extracting one or more perspective views from each frame of the sequence of frames;
determining virtual poses for each of the extracted perspective views; and
processing the one or more perspective views and the virtual poses using a three-dimensional reconstruction model.

6. The method of claim 5, wherein the three-dimensional reconstruction model is a long-LRM model.

7. The method as described in claim 1, further comprising training the one or more machine learning models using a combination of panoramic video data and panoramic image data as training data.

8. The method as described in claim 7, wherein the training further includes applying a masked diffusion loss to exclude one or more regions of individual panoramic videos from the training data.

9. The method as described in claim 1, further comprising rendering views of the traversable three-dimensional scene not represented by the spherical representation based on an input to navigate within the three-dimensional environment.

10. A system comprising:
a memory component; and
a processing device coupled to the memory component, the processing device to perform operations including:
receiving a query that specifies a visual aspect to be included in a three-dimensional scene;
generating a traversable three-dimensional scene that depicts the visual aspect by:
generating a spherical representation of the three-dimensional scene based on the query that includes a sequence of panoramic frames;
extracting one or more perspective views from each frame of the sequence of panoramic frames;
estimating virtual poses for each of the extracted perspective views; and
processing the one or more perspective views and the virtual poses using a machine learning model to reconstruct the traversable three-dimensional scene; and
presenting a three-dimensional environment that includes the traversable three-dimensional scene.

11. The system as described in claim 10, wherein the spherical representation is generated using a text-to-video diffusion model that has been fine-tuned on panoramic video data.

12. The system as described in claim 11, wherein the operations further include training the text-to-video diffusion model, and the training includes applying a masked diffusion loss to exclude one or more regions of individual panoramic videos from training data.

13. The system as described in claim 10, wherein the machine learning model used to reconstruct the traversable three-dimensional scene is a long-LRM model.

14. The system as described in claim 10, wherein the operations further include training the machine learning model using a combination of panoramic video data and panoramic image data.

15. The system as described in claim 10, wherein the operations further include rendering views of the traversable three-dimensional scene based on an input to navigate within the three-dimensional environment.

16. The system as described in claim 10, wherein the traversable three-dimensional scene includes a 3D Gaussian Splat representation.

17. A non-transitory computer-readable storage medium storing executable instructions, which when executed by a processing device, cause the processing device to perform operations comprising:
receiving a query that specifies a visual aspect to be included in a three-dimensional scene;
generating a spherical representation of the three-dimensional scene based on the query that includes a sequence of panoramic frames;
constructing a traversable three-dimensional scene by processing one or more features of the panoramic frames using one or more machine learning models; and
outputting a three-dimensional environment that includes the traversable three-dimensional scene for display.

18. The non-transitory computer-readable storage medium as described in claim 17, wherein the one or more features include perspective views and corresponding virtual camera poses extracted from the sequence of panoramic frames.

19. The non-transitory computer-readable storage medium as described in claim 17, the operations further including rendering views of the traversable three-dimensional scene based on an input to navigate within the three-dimensional environment.

20. The non-transitory computer-readable storage medium as described in claim 17, wherein generating the spherical representation includes using a text-to-video diffusion model fine-tuned on panoramic video data to process the query.
